(19) United States
(12) Patent Application Publication
(10) Pub. No.: US 2002/0029642 A1
(43) Pub. Date: Mar. 14, 2002

(54) Torque detector

(76) Inventors: Kenjiro Soejima, Tokyo (JP); Hitoshi Manta, Tokyo (JP); Masaharu Baba, Tokyo (JP); Toshiaki Yatani, Tokyo (JP)

Correspondence Address: MURAMATSU & ASSOCIATES, Suite 225, 7700 Irvine Center Drive, Irvine, CA, 92618, US

(21) Appl. No.: 09/733,814

(22) Filed: Dec. 9, 2000

(30) Foreign Application Priority Data
Sep. 14, 2000 (JP) 2000-279123

(51) Int. Cl. G01L 3/00

(52) U.S. Cl. 73/862.08

(57) ABSTRACT

There are provided a torque detection shaft loaded with a torque from outside, and a pair of magnetic field sensors and provided in the vicinity of a surface of the torque detection shaft. The torque detection shaft has magnetostrictive characteristics and also has six magnetization bands to magnetized in the circumferential direction of the torque detection shaft and polarized so that magnetization directions of the adjacent magnetization bands are opposite to each other.

### FIELD OF THE INVENTION

The present invention relates to a torque detector comprising a torque detection shaft loaded with a torque and a non-contact magnetic field sensor provided in the vicinity of the surface of this torque detection shaft.

### PRIOR ART

Recently, a magnetic ring system, a magnetization system having a shaft provided with irregular portions thereon and the like have been published as non-contact torque detection systems.

As well-known documents about the magnetic ring system, there is, for example, Japanese Patent Application Laid-Open (JP-A) No. 5-196517. A torque detector according to this publication is a detection system utilizing a stress-magnetization effect, i.e. a phenomenon that when a shaft applied with a magnetic field in circumferential direction is loaded with a torque, the magnetic field is deflected in a direction inclined with respect to the circumferential direction by an inverse Wiedemann effect. This torque detector comprises a columned shaft fitted with interference fitting in a cylindrical magnetostrictive tube (normally referred to as a magnetic ring) along the axis of the detection shaft loaded with the torque. The magnetostrictive tube is provided with a magnetic converter having one axial magnetic anisotropy in a circumferential direction around the axis and a magnetic field in the circumferential direction.

In addition, as a well-known document about a magnetization system having a shaft provided with irregular portions, there is, for example, Japanese Patent Application Laid-Open (JP-A) No. 11-101699. A torque detector according to this publication is a detection system utilizing a phenomenon caused by the inverse Wiedemann effect, as well. This torque detector comprises a shaft member loaded with a torque around its axis and provided with different regions which are formed along the axis of the shaft and have large magnetic change and small magnetic change due to a stress-magnetization effect caused by irregular portions provided on this shaft member; means for applying a magnetic field to the shaft member; and magnetic detection means for detecting magnetism of either the region having large magnetic change or the region having small magnetic change.

However, in the torque detector described in Japanese Patent Application Laid-Open (JP-A) No. 5-196517, a tolerance in interference fitting between the columned shaft and the cylindrical magnetostrictive tube (or the magnetic ring stated above) along the axis of the detection shaft loaded with the torque tends to vary, so that a tension stress applied to the magnetic ring in the circumferential direction tends to vary. Due to this, there arises a problem that detection sensitivity tends to vary.

Further, since the columned-shaft and the magnetic ring are made of different types of metal, there arises a problem that a slip is caused by a low torque (torsion stress) at the fitted section of the interference fitting because of difference in stiffness between them, so that an error is produced in a detection value and sometimes torque detection is made impossible.

Moreover, if the fitting tolerance is strictly managed so as to solve this problem, a torque detector becomes expensive. Likewise, if the fitted section is processed to have grooves such as irregular splines or the like so as to prevent slippage, working cost, management cost and the like increases, resulting in an expensive product.

Further, it is necessary to use a material having sufficient toughness to resist fitting and excellent magnetostrictive characteristics (e.g., Ni maraging steel, etc.), for the magnetic ring. These materials are special, expensive ones, resulting in an expensive torque detector as in the case of the above.

Additionally, the torque detector described in Japanese Patent Application Laid-Open (JP-A) No. 11-101699 requires a shaft member loaded with a torque around its axis provided with different regions which are formed along the axis of the shaft and have large magnetic change and small magnetic change due to a stress-magnetic effect caused by irregular portions provided on the shaft member.

As high working accuracy is required in making the irregular portions on this shaft member, working cost becomes high so that it is difficult to realize a torque detector at low cost.

In addition, the detection sensor for detecting leakage magnetic flux proportional to a stress according to the torque is positioned on the end face portion of the irregular portions. This requires positional accuracy so that it is difficult to manufacture uniform products.

### SUMMARY OF THE INVENTION

A torque detector according to the first aspect of the present invention is a torque detector comprising a torque detection shaft generating a torsion stress in accordance with a torque applied to the shaft from outside, and a non-contact magnetic field sensor provided in the vicinity of a surface of the torque detection shaft, wherein the torque detection shaft has magnetostrictive characteristics and has at least four, preferably six magnetization bands magnetized in a circumferential direction of the torque detection shaft and polarized so that magnetization directions of the adjacent magnetization bands are opposite to each other.

Due to this, if a torque is applied to the torque detection shaft, a leakage magnetic field is generated from the torque detection shaft to outside. Accordingly, it is possible to make magnetic detection with practical sensitivity even if the magnetic sensor is arranged to be a predetermined distance away from the surface of the detection shaft.

A torque detector according to the second aspect of the present invention is based on the torque detector according to the claim 1, wherein the torque detection shaft is either a solid shaft or a hollow shaft.

If the detection shaft is a hollow shaft, it can be also used as an overload protecting shaft.

A torque detector according to the third aspect of the present invention is based on the torque detector according to the claim 1 or 2, wherein the torque detection shaft having the magnetostrictive characteristics is made either of a steel containing 4% to 5% nickel, a precipitation hardened stainless steel or a martensitic stainless steel containing nickel.

Due to this, it is possible to generate an axial magnetic field sensitively based on a torsion stress generated when applying the torque.

A torque detector according to the fourth aspect of the present invention is based on the torque detector according to any one of claims 1 to 3, wherein the non-contact magnetic field sensor arranged in the vicinity of the surface of the torque detection shaft is provided for each of two groups of magnetization bands, the two groups obtained by dividing at least the four, preferably six magnetization bands magnetized on the torque detection shaft into right and left groups about a center.

Due to this, using the output signals of these two magnetic field sensors, the components of the disturbance magnetic field are canceled while those of the signal magnetic fields are added together, so that a detection signal having a good S/N ratio can be obtained.

### BRIEF DESCRIPTION OF THE DRAWINGS

FIG. 1 is an explanatory view for an external leakage magnetic field in a torque detector according to an embodiment of the present invention in a no-load state.

FIG. 2 is an explanatory view for an external leakage magnetic field in the torque detector according to the embodiment of the present invention loaded with a torque.

FIG. 3 is an operational explanatory view of a torque detection shaft provided with one magnetization band magnetized in a circumferential direction.

FIG. 4 is an operational explanatory view of the torque detection shaft provided with three magnetization bands magnetized in the circumferential direction.

FIG. 5 is an operational explanatory view of the torque detection shaft provided with six magnetization bands magnetized in the circumferential direction.

FIG. 6 is a diagram exemplifying a processing system of respective detection signals of a pair of magnetic field sensors.

### BEST MODE FOR CARRYING OUT THE INVENTION

First, the measurement principle of the present invention will be described.

FIGS. 3, 4 and 5 are operation explanatory views of torque detection shafts provided with one, three and six magnetization bands polarized in circumferential direction thereof, respectively. In FIGS. 3, 4 and 5, reference symbol 1 denotes a torque detection shaft, 2, 2a to 2f denote magnetization bands, respectively, 3a and 3b denote magnetic field sensors, respectively. In FIG. 6, 4 denotes an amplifier and 5 denotes a converter.

The torque detection shaft 1 is made of a material having magnetostrictive characteristics, e.g., a steel containing 4% to 5% Ni, a precipitation hardened stainless steel or a martensitic stainless steel containing Ni.

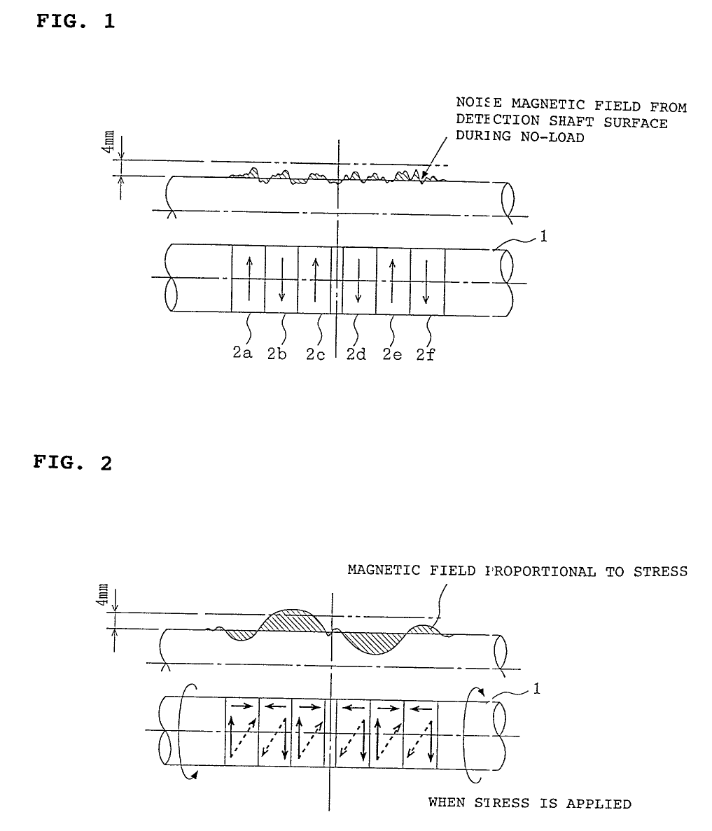

The magnetic field sensors 3a and 3b are sensors for detecting a magnetic field in a non-contact fashion which are arranged at positions away from the surface of the torque detection shaft 1 by a certain distance (about 4 mm in the embodiment shown in FIGS. 1 and 2). As a magnetic field detection system, a system capable of detecting the stress-magnetic effect of a magnetic substance is employed. For example, a coil type magnetic field sensor having a magnetic core of amorphous wire can be employed.

The torque detection shaft 1 is provided with magnetization bands 2, 2a to 2f polarized in the circumferential direction of the shaft. It is noted that the magnetization bands 2a to 2c or 2a to 2f are polarized so that the magnetization directions of the adjacent magnetization bands are opposite to each other as shown in the drawings.

As a polarization method, for example, a polarization device capable of magnetizing only one magnetization band is so set to make the magnetization polarity, for example, from a right pole to a left pole, and is brought near the torque detection shaft, so that the entire periphery of the torque detection shaft is magnetized while rotating the shaft. Next, the magnetization polarity of the polarization device is changed oppositely, i.e., from the left pole to the right pole, the polarization device of the torque detection shaft is shifted by a width of one magnetization band and brought near the torque detection shaft, so that the entire periphery of the torque detection shaft is magnetized with the opposite polarity while rotating the shaft. By repeating the above-stated steps, it is possible to polarize a desired number of magnetization bands.

In this embodiment, an example of individually polarizing the respective bands is explained. However, it is also possible to simultaneously polarize all of the magnetization bands by using a dedicated polarization device.

FIG. 3(a) shows an example of providing the torque detection shaft 1 having magnetostrictive characteristics, which is provided with one magnetization band 2 magnetized in the circumferential direction thereof. As shown in FIG. 3(b), if a torque (rotation force) is applied to the torque detection shaft 1, a torsion stress occurs in a direction at 45° with respect to a shaft axis and a magnetic field in an axial direction occurs in the magnetization band 2 based on the torsion stress. The magnetic field generated in the axial direction and the circumferential magnetic field magnetized in advance are composed to thereby deflect the magnetic field in a direction indicated by broken-line vectors inclined with respect to the circumferential direction.

The rotation direction and magnitude of the torque applied to the torque detection shaft 1 corresponds to the polarity and intensity of the magnetic field generated in the axial direction. Accordingly, if the polarity and intensity of the magnetic field generated in the axial direction of the torque detection shaft 1 can be detected, it is possible to obtain the rotation direction and the value of the applied torque.

If the number of magnetization bands 2 is one, however, the magnetic field generated in the axial direction is weak. Due to this, even if the magnetic field sensor is brought close by about 1 mm to a shaft face, detection cannot be made easily.

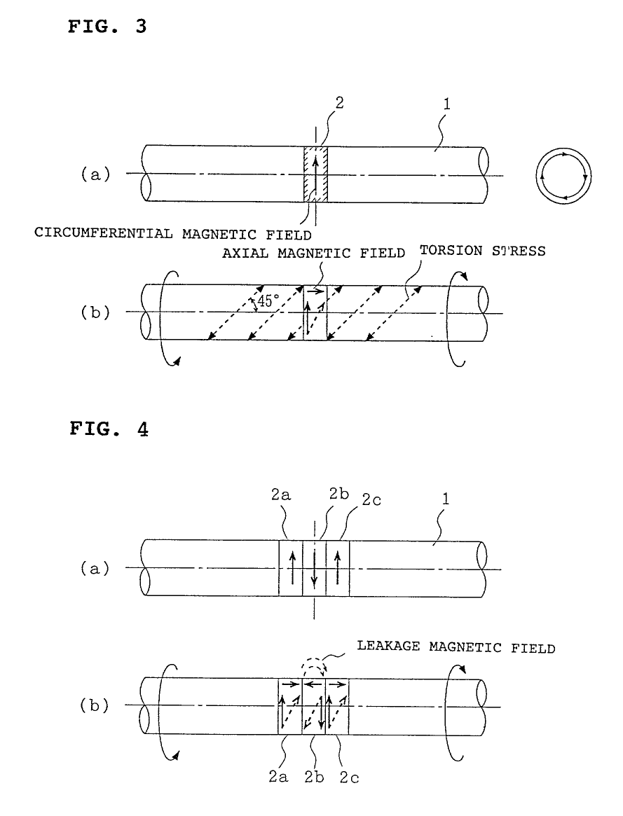

FIG. 4(a) shows an example of providing the torque detection shaft 1 with three magnetization bands 2a, 2b and 2c magnetized in the circumferential direction thereof and polarized so that the magnetization directions of the adjacent magnetization bands are opposite to each other.

FIG. 4(b) shows vectors of the magnetic fields which are generated in the magnetization bands 2a to 2c based on a torsion stress generated therein when a torque (rotation force) is applied to the torque detection shaft 1 shown in FIG. 4(a), and vectors of the circumferential magnetic fields which are magnetized in advance (both vectors are indicated by solid lines), as well as composed vectors (indicated by a broken lines) of the both vectors.

Now, attention is paid to the axial magnetic vectors which occur to the respective magnetization bands. Assuming that the axial magnetic field vectors occur from the N pole toward the S pole, the junction area between the magnetization bands 2a and 2b has an equal polarity, i.e., the S pole, and the junction area between the magnetization bands 2b and 2c has an equal polarity, i.e., the N pole. The two magnetic poles coupled with the same polarity repel each other, so that a leakage magnetic field occurs from the surface of the shaft to outside (in the air).

By detecting the leakage magnetic field leaking from the surface of the shaft in the air with the magnetic field sensor, it is possible to detect the magnetic field with practical sensitivity even if the magnetic field sensor is arranged at a position 4 to 5 mm away from the shaft face (it is explained later in detail).

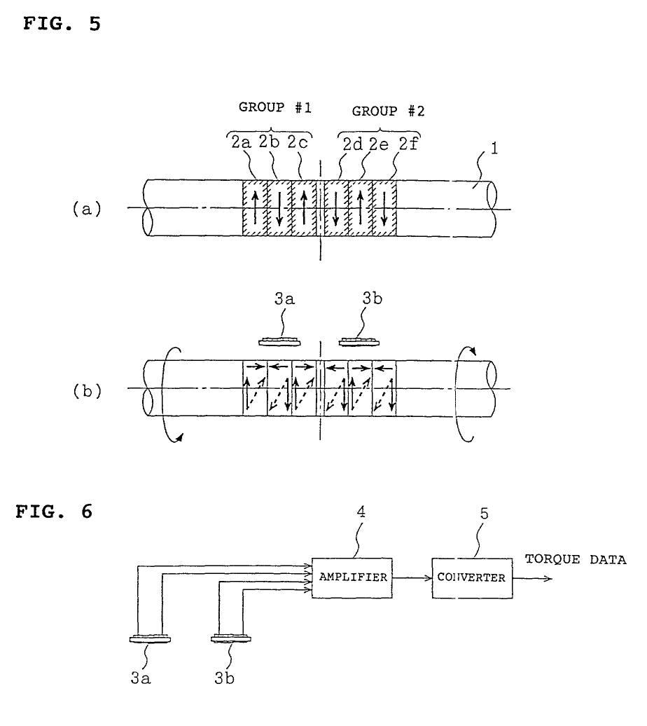

FIG. 5(a) shows an example in which six magnetization bands 2a to 2f magnetized in the circumferential direction of the torque detection shaft are divided into left and right groups about the center (group #1: magnetization bands 2a to 2c; group #2: magnetization bands 2d to 2f) and the magnetization bands are polarized so that the magnetization directions of the adjacent magnetization bands are opposite to each other.

FIG. 5(b) shows an example in which the magnetic field sensor 3a and the magnetic field sensor 3b are provided so as to correspond to the magnetization band group #1 and the magnetization band group #2, respectively, shown in FIG. 5(a), and a leakage magnetic field leaking from the surface of the shaft to outside is detected using the two magnetic field sensors 3a and 3b in a pair when a torque is applied to the torque detection shaft 1.

FIG. 6 shows an example of the processing system of the respective detection signals of the paired magnetic field sensors 3a and 3b.

The respective detection signals of the magnetic field sensors 3a and 3b are supplied to the amplifier 4. In the amplifier 4, the respective signals are amplified and then subjected to a subtraction process (which process means inverting the polarity of one of the signals and adding the polarity-inverted signal to the other signal). This is because the signals detected by the magnetic field sensors 3a and 3b based on a disturbance magnetic field have an equal polarity and are cancelled each other by the subtraction process. The detection signals of the magnetic field sensors 3a and 3b based on the external leakage magnetic field generated by the application of the torque are different from each other in polarity since the arrangement pattern of the magnetization bands of the group #1 is inverted from that of the group #2. By inverting the polarity of one of the signals having opposite polarities and adding the polarity-inverted signal to the other signal, a signal in which absolute values are added with the same polarity (substantially having a doubled amplitude value) is provided, so that a signal having a good S/N ratio can be detected.

In this way, the signal in which influence of the disturbance magnetic field has been cancelled, is supplied to the converter 5. As already stated above, the direction in forward rotation or backward rotation and the magnitude (torque value) of the torque applied to the torque detection shaft 1 correspond to the polarity and intensity of the magnetic field generated in the shaft direction of the detection shaft 1. Thus, if correlation of the polarity and amplitude value of the signal which is subjected to the subtraction process after being amplified in the amplifier 4, with the rotation direction and the torque value of the applied torque is calibrated in advance, the signal can be converted into a torque value including the rotation direction based on the calibration data.

In this way, the converter 5 outputs the converted torque data to outside and the torque data is displayed by, for example, a digital display unit which is not shown in FIG. 5.

FIGS. 1 and 2 are explanatory views for external leakage magnetic fields of the torque detector according to the embodiment of the present invention at the time of in a no-load state and a load state of an applied torque.

In FIG. 1, a total of six magnetization bands 2a to 2f in a torque detection shaft are magnetized and divided into group #1 including the magnetization bands 2a to 2c and group #2 including the magnetization bands 2d to 2f, similarly to FIG. 5. The magnetic field sensors 3a and 3b are also provided for the groups #1 and #2 respectively. A noise magnetic field emitted from the surface of the detection shaft with no-load (zero torque) is also shown in FIG. 1.

As shown in FIG. 1, if the six magnetization bands are polarized so that the magnetization directions of the adjacent magnetization bands are opposite to each other, mutual magnetic interference occurs at the boundary portions of the respective adjacent magnetization bands, an irregular noise magnetic field occurs as shown therein. Since this noise magnetic field has a similar polarity, it can be canceled to some extent by the above-stated subtraction process. However, the residual components become an offset of the measurement value during zero torque.

To remove the influence of the offset during zero torque, the magnetic sensors 3a and 3b may be gradually made away from the surface of the torque detection shaft 1, to determine an appropriate distant at which residual components of the noise magnetic field are hardly detected while the external leakage magnetic field during the application of the torque can be sufficiently detected.

As a result of the actual measurement, it has been discovered that if the sensors are made away from the torque detection shaft 1 by about 4 mm, the external leakage magnetic field generated from the torque detection shaft 1 loaded with a torque can be detected with practical sensitivity without being influenced by the noise magnetic field.

FIG. 2 shows the states of an axial magnetic field vector generated proportionally to a torsion stress and an external leakage magnetic field generated based on this magnetic field vector at the time when a torque is applied to the torque detection shaft 1 constituted as shown in FIG. 1.

As already stated above, by providing the paired magnetic field sensors 3a and 3b to be away from the axial surface of the torque detection shaft by about 4 mm, it is possible to obtain the forward or backward direction of the applied torque and a torque value as described with reference to FIG. 6.

As stated above, since the detection signals of the magnetic field sensors 3a and 3b have different polarities as shown, two signal detection components are added together by conducting subtraction processes to both of the signals, and disturbance components are canceled, so that a signal having a good S/N ratio can be detected.

As stated so far, the following advantages can be obtained from this embodiment:

(1) The six magnetization bands having a special pattern are magnetized on the torque detection shaft, so that an external leakage magnetic field is generated from the surface of the torque detection shaft when a torque is applied to the torque detection shaft. Thus, magnetic change can be detected with a practical sensitivity even if the magnetic field sensors are provided to be away from the surface of the detection shaft by about 4 mm.

(2) The six magnetization bands are divided into left and right groups and magnetic field sensors are provided for the respective groups. Using the output signals of the two magnetic field sensors, the components of the disturbance magnetic field are canceled and those of the signal magnetic field are added, whereby a highly accurate torque detector can be realized by using a detection signal having a good S/N ratio.

(3) Since the torque detection shaft can be easily machined, machining cost of components can be reduced. Namely, it is not necessary to conduct working such as a fitting between a magnetic ring and a detection shaft with accurate interference as seen in a magnetic ring system and it is not necessary to provide irregular portions on the detection shaft.

(4) Since the number of components constituting the torque detector is small, it is possible to reduce both component cost and working cost and to thereby realize a high-quality torque detector at low cost.

Meanwhile, FIG. 5(b) has shown an example in which each of the magnetic field sensors 3a and 3b detects leakage magnetic fields from the three magnetization bands provided at the torque detection shaft 1. The reason is as follows. As already described with reference to FIG. 4(b), at the two junction areas of the three magnetization bands have an equal polarity and leakage magnetic field is emitted from the two junction areas having an equal polarity. Due to this, the magnetic field sensors 3a and 3b are able to detect the leakage magnetic fields with high sensitivity. In principle, however, each of the magnetic field sensors 3a and 3b can measure leakage magnetic fields if there is one junction of the magnetization bands generating leakage magnetic fields, i.e., there are two magnetization bands. Accordingly, it is effective that the torque detection shaft 1 has at least four magnetization bands.

Description has been given while assuming that the torque detection shaft 1 is a solid shaft in the above-stated embodiment. Alternatively, the shaft 1 may be a hollow shaft.

Since the hollow shaft has a lower shearing stress than that of the solid shaft, the hollow shaft can be also used as a overload protecting shaft.

What is claimed is:

1. A torque detector comprising a torque detection shaft generating a torsion stress in accordance with a torque applied to the torque detection shaft from outside; and a non-contact magnetic field sensor provided in the vicinity of a surface of the torque detection shaft, characterized in that
said torque detection shaft has magnetostrictive characteristics and has at least four, preferably six magnetization bands magnetized in a circumferential direction of the torque detection shaft and polarized so that magnetization directions of the adjacent magnetization bands are opposite to each other.

2. A torque detector according to claim 1, characterized in that said torque detection shaft is either a solid shaft or a hollow shaft.

3. A torque detector according to claim 1 or 2, characterized in that the torque detection shaft having said magnetostrictive characteristics is made either of a steel containing 4% to 5% nickel, a precipitation hardened stainless steel or a martensitic stainless steel containing nickel.

4. A torque detector according to any one of claims 1 to 3, characterized in that the non-contact magnetic field sensor arranged in the vicinity of the surface of said torque detection shaft is provided for each of two groups of magnetization bands, said two groups being obtained by dividing at least the four, preferably six magnetization bands magnetized on said torque detection shaft into right and left groups about a center.
